(19) United States
(12) Patent Application Publication
(10) Pub. No.: US 2024/0207126 A1
(43) Pub. Date: Jun. 27, 2024

(54) Back Scratching Device And Method Of Use

(71) Applicants: Phillip Stretch, Gresham, OR (US); Robin Stretch, Gresham, OR (US)

(72) Inventors: Phillip Stretch, Gresham, OR (US); Robin Stretch, Gresham, OR (US)

(21) Appl. No.: 18/088,700

(22) Filed: Dec. 26, 2022

(51) Int. Cl. A61H 7/00

(52) U.S. Cl. CPC A61H 7/003; A61H 2201/0157; A61H 2201/0161; A61H 2201/0192; A61H 2201/1253; A61H 2201/1676; A61H 2201/1692; A61H 2205/081

(57) ABSTRACT

A back scratching device for scratching hard to reach places includes a rod, which in turn comprises a plurality of linear segments. Each pivot of a set of pivots is operationally attached to a respective linear segment and to an adjacent linear segment. Each linear segment thus is selectively angularly positionable relative to at least one adjacent linear segment. A plurality of barbs is attached to a first end of the rod. The rod can be grasped, proximate to a second end of the rod, in a hand of a user, positioning the user to manipulate the rod so that the barbs scratch a back of the user to relieve itching.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to backscratchers and more particularly pertains to a new backscratcher for scratching hard to reach places. The present invention discloses an easy to configure backscratcher that enables a user to scratch their own back.

### (2) Description of Related Art Including Information Disclosed Under 37 CFR 1.97 and 1.98

The prior art relates to backscratchers, which may comprise backscratchers that comprise a pair of elongate arcuate arms, which are pivotally attached with scratching means on one end and a handle on the other, and which can be positioned in a U-shaped configuration for scratching one's back. These backscratchers are rather cumbersome to use and to store when not in use. Other backscratchers comprise extensible rods with scratching means on one end, which may have motors on the other end to induce movement of the scratching means. The rods of these backscratchers are linear, making it difficult to position the scratching means on one's back. Related prior art comprises articulating elongate handles for shaving hard to reach places. What is lacking in the prior art is a backscratcher comprising a rod comprising a plurality of linear segments that are connected by pivots, thereby allowing the rod to be selectively configured. A plurality of barbs is attached to one end of the rod.

### BRIEF SUMMARY OF THE INVENTION

An embodiment of the disclosure meets the needs presented above by generally comprising a rod, which in turn comprises a plurality of linear segments. Each pivot of a set of pivots is operationally attached to a respective linear segment and to an adjacent linear segment. Each linear segment thus is selectively angularly positionable relative to at least one adjacent linear segment. A plurality of barbs is attached to a first end of the rod. The rod is configured to be grasped, proximate to a second end of the rod, in a hand of a user, positioning the user to manipulate the rod so that the barbs scratch a back of the user to relieve itching.

Another embodiment of the disclosure includes a method of scratching one's back, comprises a provision step that entails providing a back scratching device, according to the disclosure above. A setup step of the method is positioning the plurality of linear segments in a desired configuration. First and second operational steps are grasping the rod proximate to a second end of the rod and manipulating the rod so that the barbs scratch a back of the user, respectively.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of a back scratching device according to an embodiment of the disclosure.

FIG. 2 is a side view of an embodiment of the disclosure.

FIG. 3 is a front view of an embodiment of the disclosure.

FIG. 4 is an in-use view of an embodiment of the disclosure.

FIG. 5 is a flow diagram for a method utilizing an embodiment of the disclosure.

### DETAILED DESCRIPTION OF THE INVENTION

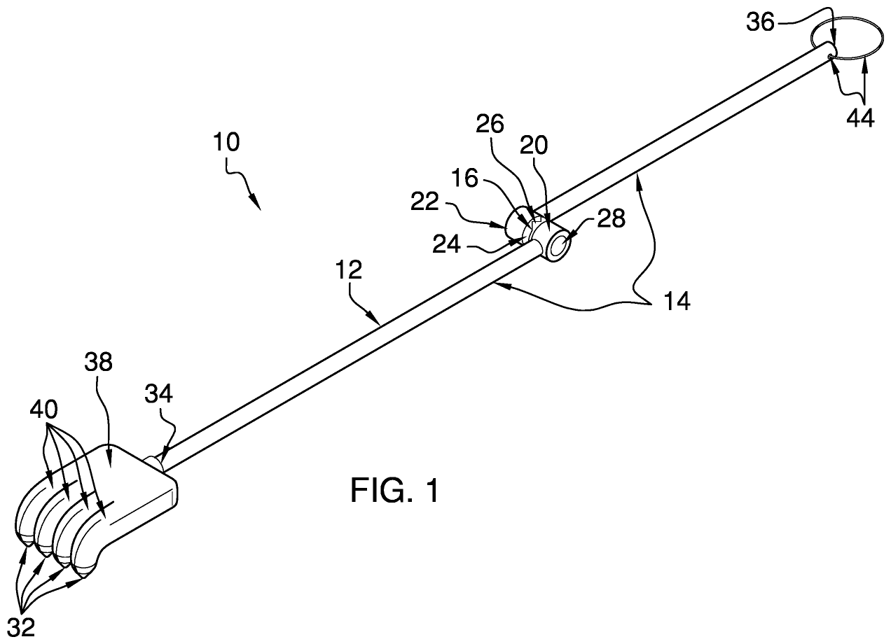

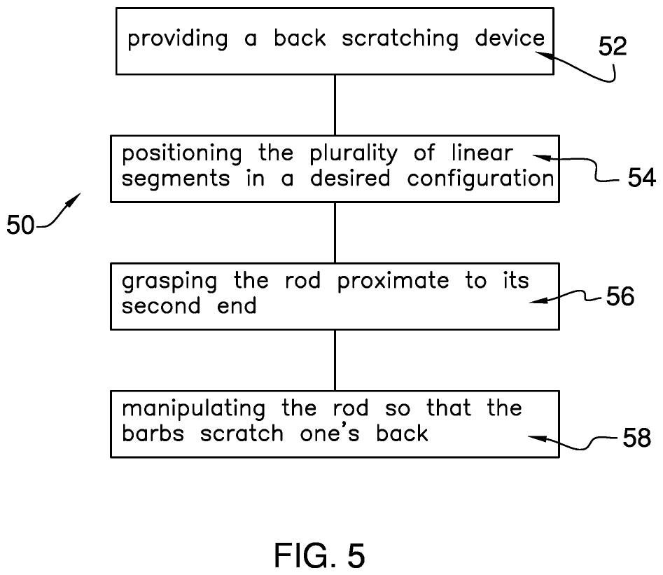

With reference now to the drawings, and in particular to FIGS. 1 through 5 thereof, a new backscratcher embodying the principles and concepts of an embodiment of the disclosure and generally designated by the reference numeral 10 will be described.

As best illustrated in FIGS. 1 through 5, the back scratching device 10 generally comprises a rod 12, which in turn comprises a plurality of linear segments 14. The plurality of linear segments 14 may comprise two linear segments 14, as shown in FIG. 1, although the present invention anticipates the plurality of linear segments 14 comprising three or more linear segments 14. The present invention anticipates one or more of the linear segments 14 comprising a plurality of nested sections and thus being selectively extensible.

Each pivot 16 of a set of pivots 16 is operationally attached to a respective linear segment 14 and to an adjacent linear segment 14. Each linear segment 14 thus is selectively angularly positionable relative to at least one adjacent linear segment 14. The pivot 16 enables positioning of a respective linear segment 14 at an angle 18 of between 0° and 180° relative to an adjacent linear segment 14. The angle 18 between the respective linear segment 14 and the adjacent linear segment 14 is adjustable in increments of 10°.

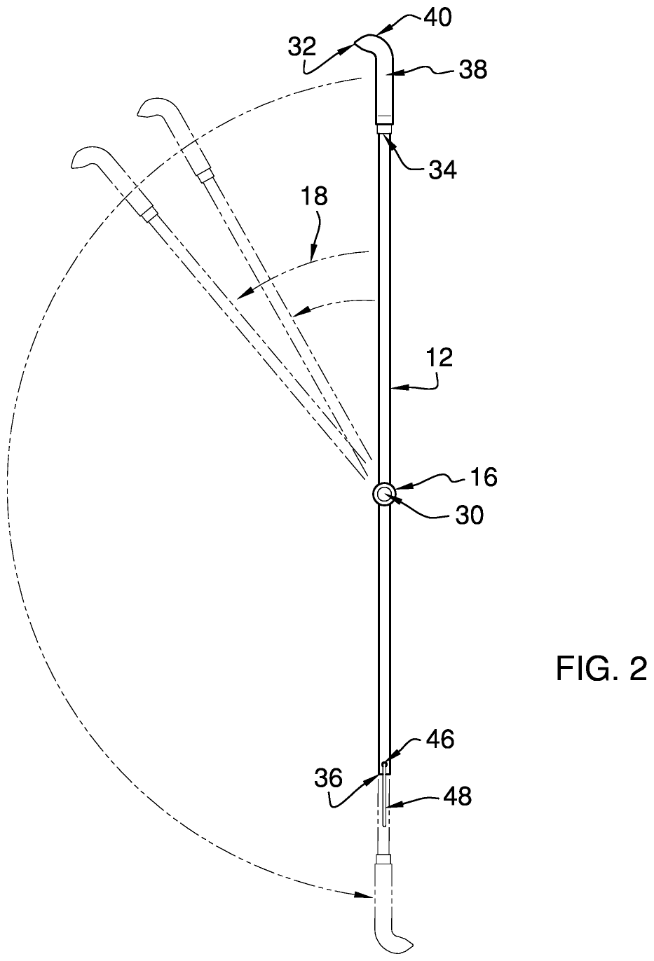

The pivot 16 comprises a first spur gear 20, which is attached to a respective linear segment 14, and a second spur gear 22, which is attached to an adjacent linear segment 14 so that teeth 24 of the second spur gear 22 are operationally engaged to cogs 26 of the first spur gear 20. An actuator 28 is attached to one of the first spur gear 20 and the second spur gear 22 and is operationally engaged to the other of the first spur gear 20 and the second spur gear 22. The actuator 28 is selectively actuatable to disengage the teeth 24 from the cogs 26, thereby allowing for rotation of the respective linear segment 14 relative to the adjacent linear segment 14. The actuator 28 may comprise a spring loaded button 30, as shown in FIG. 2.

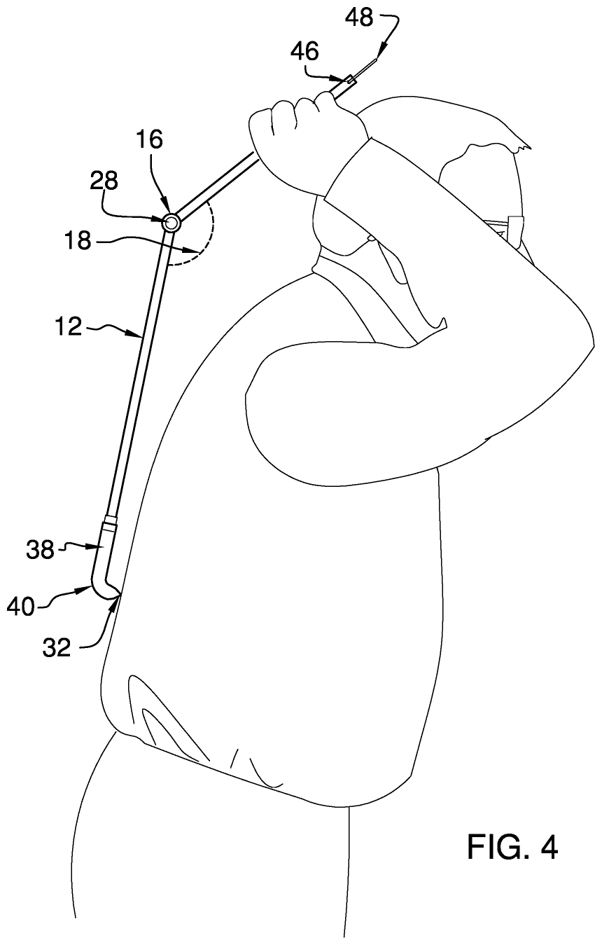

A plurality of barbs 32 is attached to a first end 34 of the rod 12. The rod 12 is configured to be grasped, proximate to its second end 36, in a hand of a user, positioning the user to manipulate the rod 12 so that the barbs 32 scratch a back of the user to relieve itching, as shown in FIG. 4.

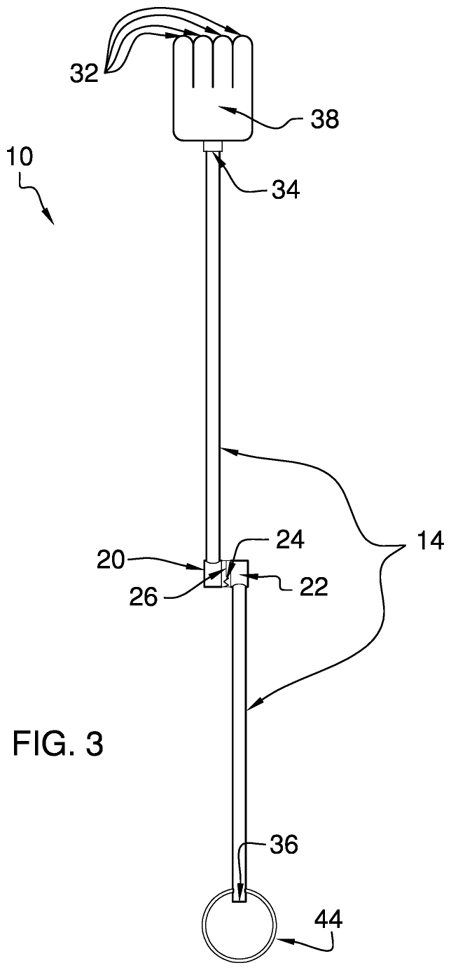

A plate 38 is attached to and is positioned between the rod 12 and the plurality of barbs 32. A plurality of digits 40 is attached to and extends from the plate 38 distal from the rod 12. As shown in FIG. 3, the plate 38 and the digits 40 together are hand shaped. The barbs 32 are attached singly to the digits 40 distal from the plate 38.

The back scratching device 10 also may include a fastener 44, which is attached to the rod 12 proximate to the second end 36. The fastener 44 is configured to selectively attach to a substrate to removably attach the rod 12 to the substrate, thereby allow for stowage the rod 12 when the back scratching device 10 is not in use. The fastener 44 may comprise a hole 46, through which a hook that is attached to the substrate, such as a wall, could be inserted to hang the back scratching device 10 from the substrate. As shown in FIG. 3, a ring 48 is positioned through the hole 46 is configured for insertion of an element that extends from the substrate, such as a hook, so that the rod 12 hangs from the element. The ring 48 comprises rope, cord, wire, or the like.

In use, the back scratching device 10 enables a method of scratching one's back 50, which comprises a provision step 52 that entails providing a back scratching device 10, according to the specification above. A setup step 54 of the method 50 is positioning the plurality of linear segments 14 in a desired configuration, as shown in FIG. 4, but which may vary depending on the user's requirements. A first operational step 56 of the method 50 is grasping the rod 12 proximate to its second end 36. A second operational step 58 of the method 50 is manipulating the rod 12 so that the barbs 32 scratch the back of the user. The device in particularly useful in scratching one's acnestis.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A back scratching device comprising:
a rod comprising a plurality of linear segments;
a set of pivots, each pivot being operationally attached to a respective linear segment and to an adjacent linear segment, such that each linear segment is selectively angularly positionable relative to at least one adjacent linear segment; and
a plurality of barbs attached to a first end of the rod, wherein the rod is configured for grasping, proximate to a second end of the rod, in a hand of a user, positioning the user for manipulating the rod such that the barbs scratch a back of the user to relieve itching.

2. The back scratching device of claim 1, wherein the plurality of linear segments comprises two linear segments.

3. The back scratching device of claim 1, wherein the pivot enables positioning of a respective linear segment at an angle of between 0° and 180° relative to an adjacent linear segment.

4. The back scratching device of claim 1, wherein an angle between a respective linear segment and an adjacent linear segment is adjustable in increments of 10°.

5. The back scratching device of claim 1, wherein the pivot comprises:
a first spur gear attached to a respective linear segment;
a second spur gear attached to an adjacent linear segment, such that teeth of the second spur gear are operationally engaged to cogs of the first spur gear; and
an actuator attached to one of the first spur gear and the second spur gear and operationally engaged to the other of the first spur gear and the second spur gear, such that the actuator is selectively actuatable for disengaging the teeth from the cogs for rotating the respective linear segment relative to the adjacent linear segment.

6. The back scratching device of claim 5, wherein the actuator comprises a spring loaded button.

7. The back scratching device of claim 1, further including:
a plate attached to and positioned between the and the plurality of barbs; and
a plurality of digits attached to and extending from the plate distal from the rod, such that the plate and the digits together are hand shaped, the barbs being attached singly to the digits distal from the plate.

8. The back scratching device of claim 7, wherein each digit is arcuate.

9. The back scratching device of claim 1, further including a fastener attached to the rod proximate to the second end, the fastener being configured for selectively attaching to a substrate for removably attaching the rod to the substrate, wherein the fastener is configured for attaching to the substrate for stowing the rod.

10. The back scratching device of claim 9, wherein the fastener comprises:
a hole; and
a ring positioned through the hole, wherein the ring is configured for insertion of an element extending from the substrate, such that the rod hangs from the element, the ring comprising rope, cord, or wire.

11. A back scratching device comprising:
a rod comprising a plurality of linear segments, the plurality of linear segments comprising two linear segments;
a set of pivots, each pivot being operationally attached to a respective linear segment and to an adjacent linear segment, such that each linear segment is selectively angularly positionable relative to at least one adjacent linear segment, the pivot enabling positioning of a respective linear segment at an angle of between 0° and 180° relative to an adjacent linear segment, an angle between the respective linear segment and the adjacent linear segment being adjustable in increments of 10°, the pivot comprising:
a first spur gear attached to a respective linear segment,
a second spur gear attached to an adjacent linear segment, such that teeth of the second spur gear are operationally engaged to cogs of the first spur gear, and
an actuator attached to one of the first spur gear and the second spur gear and operationally engaged to the other of the first spur gear and the second spur gear, such that the actuator is selectively actuatable for disengaging the teeth from the cogs for rotating the respective linear segment relative to the adjacent linear segment, the actuator comprising a spring loaded button;
a plurality of barbs attached to a first end of the rod, wherein the rod is configured for grasping, proximate to a second end of the rod, in a hand of a user, positioning the user for manipulating the rod such that the barbs scratch a back of the user to relieve itching;
a plate attached to and positioned between the and the plurality of barbs;
a plurality of digits attached to and extending from the plate distal from the rod, such that the plate and the digits together are hand shaped, the barbs being attached singly to the digits distal from the plate, each digit being arcuate; and
a fastener attached to the rod proximate to the second end, the fastener being configured for selectively attaching to a substrate for removably attaching the rod to the substrate, wherein the fastener is configured for attaching to the substrate for stowing the rod, the fastener comprising:
a hole, and
a ring positioned through the hole, wherein the ring is configured for insertion of an element extending from the substrate, such that the rod hangs from the element, the ring comprising rope, cord, or wire.

13. A method of scratching one's back comprising the steps of:
providing a back scratching device comprising:
a rod comprising a plurality of linear segments,
a set of pivots, each pivot being operationally attached to a respective linear segment and to an adjacent linear segment, such that each linear segment is selectively angularly positionable relative to at least one adjacent linear segment, and
a plurality of barbs attached to a first end of the rod;
positioning the plurality of linear segments in a desired configuration;
grasping the rod proximate to its second end; and
manipulating the rod such that the barbs scratch a back of the user.
